(19) United States
(12) Patent Application Publication
(10) Pub. No.: US 2020/0316833 A1
(43) Pub. Date: Oct. 8, 2020

(54) INJECTION MOLDING METHOD WITH METALLIC PIGMENT USING MAGNETIC FIELD

(71) Applicant: Ford Motor Company, Dearborn, MI (US)

(72) Inventor: Junko PAUKEN, CANTON, MI (US)

(73) Assignee: Ford Motor Company, Dearborn, MI (US)

(21) Appl. No.: 16/906,616

(22) Filed: Jun. 19, 2020

Related U.S. Application Data
(62) Division of application No. 15/852,979, filed on Dec. 22, 2017.
Application No. 15/852,979 is a continuation of application No. PCT/US2015/037164, filed on Jun. 23, 2015.

(51) Int. Cl. B29C 45/17; B29C 45/00; B29C 33/16; B29C 33/38; B29C 45/26

(52) U.S. Cl. CPC B29C 45/1701; B29C 45/0013; B29C 33/16; B29K 2105/0032; B29C 45/26; B29K 2995/0008; B29C 2045/0015; B29C 33/38

(57) ABSTRACT

A method for molding a part includes forming a mold having a part cavity and an associated electromagnet, placing resin in the part cavity, the resin including a ferromagnetic pigment, energizing the electromagnet and moving the ferromagnetic pigment towards an A-surface area of the part, and curing the resin with the ferromagnetic pigment concentrated at the A-surface area of the part. The A-surface of the part is free of flow marks and dark spots. Also, the ferromagnetic pigment is introduced into the resin before the resin is placed in the part cavity, or in the alternative, the ferromagnetic pigment is introduced into the resin after the resin is placed in the part cavity.

### CROSS-REFERENCE TO RELATED APPLICATIONS

This application is a divisional application of U.S. application Ser. No. 15/852,979 filed on Dec. 22, 2017, which claims the benefit of and priority to International Application No. PCT/US2015/037164, filed on Jun. 23, 2015. The disclosure of the above applications are incorporated herein by reference.

### FIELD

The present disclosure relates to injection molding methods of materials having metallic pigment. More particularly, the present disclosure relates to injection molding methods that have metallic pigment dispersed in a resin.

### BACKGROUND

The statements in this section merely provide background information related to the present disclosure and may not constitute prior art.

Popular color trends in consumer products include various metallic or polychromatic paint colors. The appearance of stainless steel in kitchen appliances and metallic surfaces on electronic products are very popular among consumers. Enthusiasm for metallic paint extends to exterior paint schemes for automotive vehicles. This type of paint is often preferred by vehicle buyers as it highlights the contours and bodywork of the vehicle more than solid paint. Metallic paint also renders the paint a sparkling effect, thus adding to the overall attractiveness of the vehicle.

As an extension of exterior metallic paint, vehicle purchasers also frequently prefer metallic decorative parts in the automotive interior. Some of these interior components are made out of actual metal. However, many of them are made out of other materials such as plastic and are then decorated to appear to be metal.

One way to decorate plastic is to overcoat the substrate using a paint or a film, but this approach can be relatively expensive and is prone to imperfections. In order to reduce manufacturing cost, many companies are working on perfecting injection molding methods using metallic pigment in the resins in an effort to eliminate the painting process.

While the theory has merit, in practice manufacturers have found that when using metallic pigment in resins, the orientation of the metallic pigment in the resin cannot be controlled. As a result, the metallic pigment sometimes shows up as flow marks or dark spots on the A-surface. In addition, when the part being molded is relatively thick, metallic pigment is often wasted since the pigment is only needed on the A-surface.

Manufacturers found that a way to reduce the use of metallic pigment in an injection molded part is to design a part with a two shot molding process. In the first step of the process, metallic resin is used to shoot the class-A surface. The second part of the two-step process is to shoot another non-metallic resin behind the first resin. While resulting in a savings of metallic pigment, the two shot molding process requires a special two shot injection molding machine, adding to manufacturing cost. In addition, two-shot molding increases cycle time.

Accordingly, finding an efficient and economical solution to mold vehicle interior components using a metallic pigment in the resin that avoids flow marks or dark spots while minimizing wastage is a desirable goal for automotive manufacturers.

### SUMMARY

The present disclosure overcomes the issues associated with known approaches to forming parts having metallic pigments.

In one form of the present disclosure, a method for molding a part includes forming a mold having a part cavity and an associated electromagnet, placing resin in the part cavity, the resin including a ferromagnetic pigment, energizing the electromagnet and moving the ferromagnetic pigment towards an A-surface area of the part, and curing the resin with the ferromagnetic pigment concentrated at the A-surface area of the part. In some variations, an A-surface of the part is free of flow marks and dark spots.

In at least one variation, the ferromagnetic pigment is introduced into the resin before the resin is placed in the part cavity, while in another variation the ferromagnetic pigment is introduced into the resin after the resin is placed in the part cavity.

In some variations, the electromagnet is selectively energized and de-energized during moving the ferromagnetic pigment towards the A-surface area of the part and/or the electromagnet is selected from the group consisting of a coil and a grid.

In at least one variation, the ferromagnetic pigment provides a desired color to an A-surface of the part. Also, in some variations the method includes removing the part from the part cavity and installing the part in an interior of a vehicle without painting or applying a film on the A-surface of the part.

In another form of the present disclosure, a method for molding a part for a vehicle using a mold having a part cavity and an associated electromagnet positioned adjacent to a wall of the part cavity that will define an A-surface of the part is provided. The method includes placing resin with a ferromagnetic pigment in the part cavity, energizing the electromagnet and moving the ferromagnetic pigment towards the wall of the mold cavity that will define the A-surface of the part, curing the resin, and removing the part from the mold cavity. The ferromagnetic pigment is concentrated at an A-surface area of the part, and in some variation the ferromagnetic pigment provides a desired color to the A-surface of the part. And in at least one variation, the A-surface of the part is free of flow marks and dark spots.

In some variations, the ferromagnetic pigment is introduced into the resin before the resin is placed in the part cavity, while in other variations the ferromagnetic pigment is introduced into the resin after the resin is placed in the part cavity.

In at least one variation, the method further includes installing the part in an interior of a vehicle without painting or applying a film on the A-surface of the part.

In still another form of the present disclosure, method for molding a part for a vehicle includes placing resin including a ferromagnetic pigment in a part cavity of a mold having an electromagnet positioned adjacent to a wall of the part cavity that will define an A-surface of the part, energizing the electromagnet and moving the ferromagnetic pigment towards the wall of the mold cavity that will define the A-surface of the part, curing the resin, and removing the part from the mold cavity. The ferromagnetic pigment is concentrated at an A-surface area of the part such that the A-surface has a desired color and is not painted or covered with a film prior to be installed in an interior of the vehicle. And in some variations, the A-surface of the part is free of flow marks and dark spots.

In at least one variation, the ferromagnetic pigment is introduced into the resin before the resin is placed in the part cavity, while in other variations the ferromagnetic pigment is introduced into the resin after the resin is placed in the part cavity.

In some variations, the electromagnet is selected from the group consisting of a coil and a grid, and in at least one variation, the electromagnet is selectively energized and de-energized during moving the ferromagnetic pigment towards the wall of the part cavity that will define an A-surface of the part.

The above advantages and other advantages and features will be readily apparent from the following detailed description of the various forms of the present disclosure when taken in connection with the accompanying drawings.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a diagrammatic illustration of a sectional view of a mold having metallic pigment dispersed in a resin and distributed throughout a part body according to the prior art;

FIG. 2 is a diagrammatic illustration of a sectional view of a mold having metallic pigment dispersed in a resin and concentrated in a surface of a part under the influence of a magnetic field according to the present disclosure;

FIG. 3 is a diagrammatic illustration of a sectional view of a mold having an electromagnet formed from coils of wire according to the present disclosure;

FIG. 4 is a diagrammatic illustration of a perspective view of the mold of FIG. 3 in which the mold has electromagnet formed from coils of wire according to the present disclosure;

FIG. 5 is a diagrammatic illustration of a sectional view of a mold having an electromagnet formed from a wire grid according to the present disclosure;

and

FIG. 6 is a diagrammatic illustration of a perspective view of the mold of FIG. 5 in which the mold has an electromagnet formed from a wire grid according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In the following figures, the same reference numerals will be used to refer to the same components. In the following description, various operating parameters and components are described for different constructed forms. These specific parameters and components are included as examples and are not meant to be limiting.

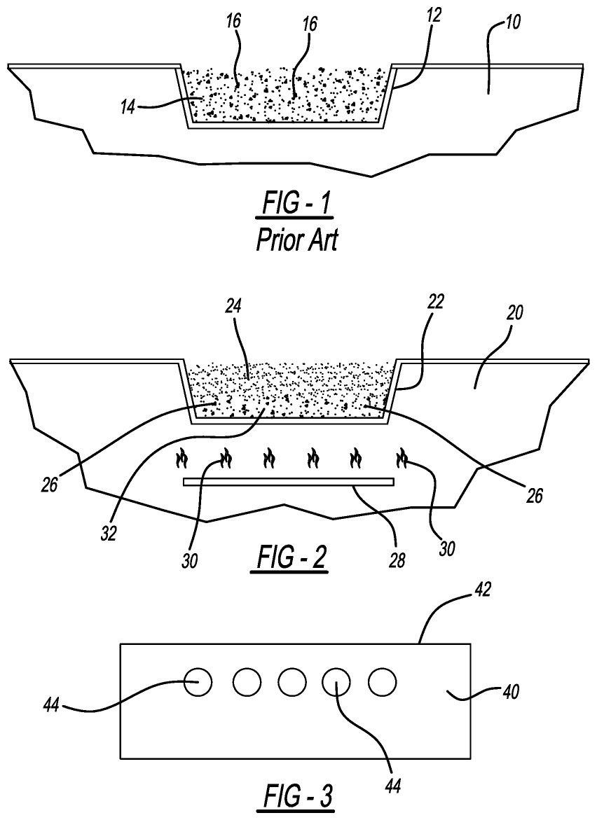

Referring to FIG. 1, a diagrammatic illustration of a sectional view of a mold 10 is illustrated according to the prior art. The mold 10 includes a part cavity 12 formed therein. A resin 14 having metallic pigment 16 dispersed therein is illustrated. As illustrated, the metallic pigment 16 is dispersed throughout the resin 14, resulting in wasted pigment since the metallic appearance is only needed on the A-surface. The wasting of metallic pigment is particularly an issue in the case where a very thick part is being molded. This approach to part molding also may result in undesirable flow marks or dark spots on the A-surface as the orientation of the metallic pigment 16 in the resin 14 cannot be controlled according to previous approaches to part molding.

The present disclosure overcomes the challenges faced by prior art approaches of molding parts with metallic pigment in the resin. Particularly, the present disclosure provides for the use of ferromagnetic pigment in resins and magnetic field adjacent the mold in the injection molding tool to thereby reduce the use of metallic pigment and, as a result, reduce manufacturing cost while providing an excellent A-surface that is free of flow marks and dark spots.

FIGS. 2 through 6 illustrate the system for molding parts according to the present disclosure relying on the presence of a magnetic field. In general, ferromagnetic pigment is attracted to a magnetic field. When a magnetic field is introduced to the cavity of tool while resin is still molten, the ferromagnetic pigment will move to the surface of the part. The ferromagnetic pigment may be added to resin before the resin is placed in the part cavity. Alternatively, the ferromagnetic pigment may be added to the resin after the resin is placed in the part cavity. This action is illustrated diagrammatically in FIG. 2 in which a mold 20 having a mold cavity 22 is shown. The mold 20 is typically composed of a metal, such as steel. A resin 24 therein is shown. Ferromagnetic pigment 26 is present in the resin 24. Because of the presence of an electromagnet 28 that generates a magnetic field 30 when energized, the ferromagnetic pigment 26 is concentrated adjacent the electromagnet 28 in an area 32 that, once molded, will become the A-surface 32 of the part.

By placing the electromagnet 28 relatively close to the mold cavity 22, the electromagnetic field 30 is strong enough to concentrate the ferromagnetic pigment 26 in the A-surface area 32. The electromagnetic 28 may be selectively energized or de-energized by a circuit-interrupting switch.

FIG. 2 illustrates a generic electromagnet 28. FIGS. 3 through 6 illustrate specific forms of the type of electromagnet that may be used in the system of the present disclosure. It is to be understood that the illustrated and discussed forms of the electromagnet are suggestive only and are not intended as being limiting.

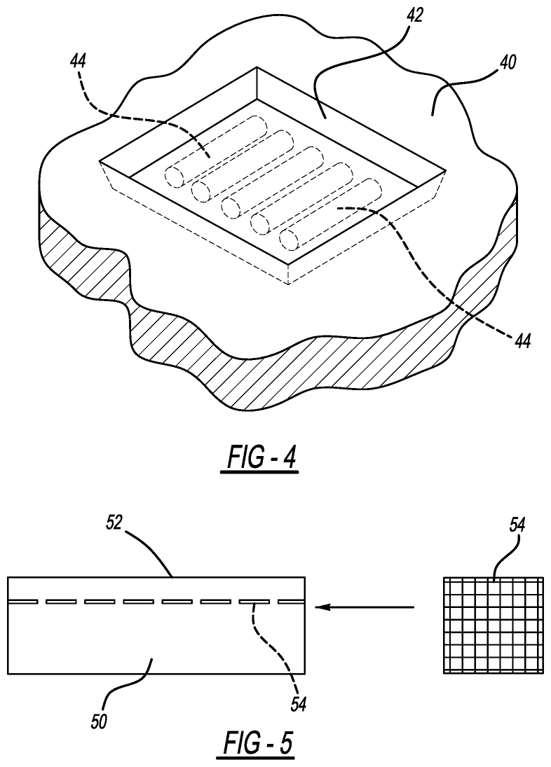

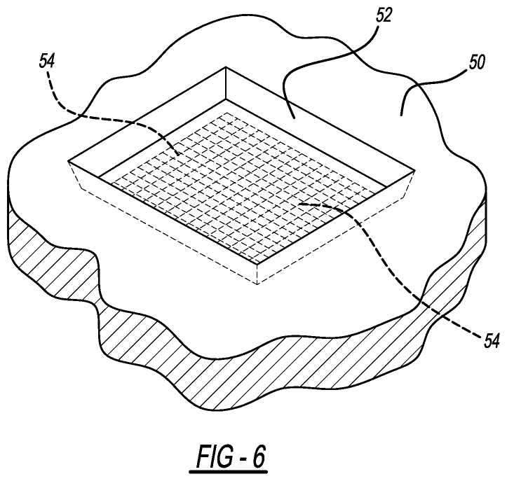

FIGS. 3 and 4 illustrate one form of the system of the present disclosure in which the electromagnet is a coil. FIGS. 5 and 6 illustrate another form of the system of the present disclosure in which the electromagnet is a grid.

Referring to FIG. 3, a mold 40 is shown in cross section. A part cavity 42 is formed on the mold 40. The mold 40 includes wire coils 44 placed in holes strategically formed in the mold 40, typically formed of a metal such as steel. The number and placement of the wire coils 44 as shown in FIG. 3 is only suggestive and is not intended as being limiting.

In FIG. 4, the mold 40 is shown in perspective view. The mold cavity 42 is of a rectangular shape but can be of any shape as the rectangular shape is shown for illustrative purposes only. The wire coils 44 are embedded in the mold 40 at a location below and adjacent to the mold cavity 42.

As an alternative to wire coils, the electromagnet of the present disclosure may be a sheet of metal or may be a grid, such as is illustrated in FIGS. 5 and 6.

Referring to FIG. 5, a mold 50 is shown in cross section. A part cavity 52 is formed on the mold 50. The mold 50 includes a wire grid 54 that is illustrated in section view as well as in plan view in FIG. 5. The part cavity 52 may be of the one-piece type as shown in FIGS. 3 and 4 or may be of the two-piece variety. Regardless or the type of part cavity, the wire grid 54 is positioned in the mold 50 at a location below and adjacent to the mold cavity 52.

In FIG. 6, the mold 50 is shown in perspective view. The mold cavity 52 is of a rectangular shape but can be of any shape as the rectangular shape is shown for illustrative purposes only. The wire grid 54 is embedded in the mold 50 at a location below and adjacent to the mold cavity 52.

In use, a mold is formed having a part cavity and an electromagnet placed in a location adjacent the part cavity. A quantity of resin is placed in the part cavity, together with a quantity of ferromagnetic pigment. The electromagnet is energized, causing the ferromagnetic pigment to move in the direction of the electromagnetic, thus forming an area of concentrated pigment. This concentrated area is the A-surface once the part is cured. The result is a part free of flow marks and dark spots on the A-surface.

One skilled in the art will readily recognize from such discussion, and from the accompanying drawings and claims that various changes, modifications and variations can be made therein without departing from the true spirit and fair scope of the present disclosure as defined by the following claims.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for molding a part comprising the steps of:
forming a mold having a part cavity and an associated electromagnet;
placing resin in the part cavity, the resin including a ferromagnetic pigment;
energizing the electromagnet and moving the ferromagnetic pigment towards an A-surface area of the part; and
curing the resin, wherein the ferromagnetic pigment is concentrated at the A-surface area of the part.

2. The method for molding a part of claim 1, wherein an A-surface of the part is free of flow marks and dark spots.

3. The method for molding a part of claim 1, wherein the ferromagnetic pigment is introduced into the resin before the resin is placed in the part cavity.

4. The method for molding a part of claim 1, wherein the ferromagnetic pigment is introduced into the resin after the resin is placed in the part cavity.

5. The method for molding a part of claim 1, wherein the electromagnet is selectively energized and de-energized during moving the ferromagnetic pigment towards the A-surface area of the part.

6. The method for molding a part of claim 1, wherein the ferromagnetic pigment provides a desired color to an A-surface of the part.

7. The method for molding a part of claim 1 further comprising removing the part from the part cavity and installing the part in an interior of a vehicle without painting or applying a film on the A-surface of the part.

8. The method for molding a part of claim 1, wherein the electromagnet is selected from the group consisting of a coil and a grid.

9. A method for molding a part for a vehicle using a mold having a part cavity and an associated electromagnet positioned adjacent to a wall of the part cavity that will define an A-surface of the part, the method comprising:
placing resin in the part cavity, the resin including a ferromagnetic pigment;
energizing the electromagnet and moving the ferromagnetic pigment towards the wall of the mold cavity that will define the A-surface of the part;
curing the resin; and
removing the part from the mold cavity, wherein the ferromagnetic pigment is concentrated at an A-surface area of the part.

10. The method for molding a part of claim 9, wherein the ferromagnetic pigment provides a desired color to the A-surface of the part.

11. The method for molding a part of claim 9, wherein the A-surface of the part is free of flow marks and dark spots.

12. The method for molding a part of claim 9, wherein the ferromagnetic pigment is introduced into the resin before the resin is placed in the part cavity.

13. The method for molding a part of claim 9, wherein the ferromagnetic pigment is introduced into the resin after the resin is placed in the part cavity.

14. The method for molding a part of claim 9 further comprising installing the part in an interior of a vehicle without painting or applying a film on the A-surface of the part.

15. A method for molding a part for a vehicle, the method comprising:
placing resin including a ferromagnetic pigment in a part cavity of a mold, wherein the mold comprises an electromagnet positioned adjacent to a wall of the part cavity that will define an A-surface of the part;
energizing the electromagnet and moving the ferromagnetic pigment towards the wall of the mold cavity that will define the A-surface of the part;
curing the resin; and
removing the part from the mold cavity, wherein the ferromagnetic pigment is concentrated at an A-surface area of the part such that the A-surface has a desired color and is not painted or covered with a film prior to be installed in an interior of the vehicle.

16. The method for molding a part of claim 15, wherein the A-surface of the part is free of flow marks and dark spots.

17. The method for molding a part of claim 15, wherein the ferromagnetic pigment is introduced into the resin before the resin is placed in the part cavity.

18. The method for molding a part of claim 15, wherein the ferromagnetic pigment is introduced into the resin after the resin is placed in the part cavity.

19. The method for molding a part of claim 15, wherein the electromagnet is selected from the group consisting of a coil and a grid.

20. The method for molding a part of claim 15, wherein the electromagnet is selectively energized and de-energized during moving the ferromagnetic pigment towards the wall of the part cavity that will define an A-surface of the part.
